(19) United States
(12) Patent Application Publication
(10) Pub. No.: US 2010/0167914 A1
(43) Pub. Date: Jul. 1, 2010

(54) NANO-SCALE CATALYSTS

(75) Inventors: Darren ANDERSON, Toronto (CA); Anjan Kumar DAS, Toronto (CA); Jose Amado DINGLASAN, Toronto (CA)

Correspondence Address: CHOATE, HALL & STEWART LLP, TWO INTERNATIONAL PLACE, BOSTON, MA, 02110, US

(73) Assignee: VIVE NANO, INC., Toronto (CA)

(21) Appl. No.: 12/644,460

(22) Filed: Dec. 22, 2009

Related U.S. Application Data
(60) Provisional application No. 61/141,095, filed on Dec. 29, 2008.

(51) Int. Cl. B01J 31/06; B01J 21/16; H01B 1/12; H01B 1/02; H01B 1/10

(52) U.S. Cl. 502/80; 502/159; 252/500; 252/520.2; 252/519.4; 977/773

(57) ABSTRACT

A method includes collapsing a polymer on a precursor moiety including a catalyst to form a composite having the polymer and the precursor moiety; and forming a nanoparticle from the composite.

### CROSS REFERENCES TO RELATED APPLICATIONS

This application claims priority to U.S. Provisional Patent Application Ser. No. 61/141,095 filed on Dec. 29, 2008, the entire contents of which are hereby incorporated by reference.

### TECHNICAL FIELD

The invention relates to catalysts, method of making catalysts, and methods of using catalysts.

### BACKGROUND

Catalysts are materials that can accelerate chemical reactions. An example of a catalyst is a semiconductor that is photocatalytic, so the catalyst can catalyze different kinds of reactions when illuminated by light of sufficient energy. The catalyst can be in the form of nanometer-sized materials with large effective surface areas (sometimes called “nanoparticles”) that are immobilized on a support.

### SUMMARY

The invention relates to catalysts, method of making catalysts, and methods of using catalysts.

In one aspect, the invention features catalytic systems including nanometer-scale precursor moieties encapsulated by one or more polymers forming a photocatalyst. In some embodiments, the nanocatalysts are carried by a solid support, which can be functionalized or not functionalized. The catalytic systems can provide, among other things, high specific surface areas, high dispersions of active components, high conversion rates, and/or high selectivity. The catalytic systems can be easy to handle, easy to separate, and easily to re-use, which can lower the cost of use and decrease their environmental impact.

In another aspect, the invention features methods of producing polymer-encapsulated precursor moieties to form photocatalysts. In some embodiments, the polymer includes one or more polyelectrolytes. The polyelectrolyte(s) can have a high molecular weight (e.g. greater than approximately 100,000 Daltons) or a low molecular weight (e.g., less than or equal to approximately 100,000 Daltons).

In another aspect, the invention features a method including collapsing a polymer on a precursor moiety including a catalyst to form a composite having the polymer and the precursor moiety; and forming a nanoparticle from the composite.

Embodiments may include one or more of the following features. The polymer includes a polyelectrolyte. The polyelectrolyte includes poly(allylamine hydrochloride) (PAAH), poly(diallyldimethylammonium chloride) (PDDA), polyacrylic acid (PAA), poly(methacrylic acid), poly(styrene sulfonate) (PSS), and/or poly(2-acrylamido-2-methyl-1-propane sulphonic acid) (PAMCS). The polymer has a molecular weight more than approximately 100,000 D.

The catalyst can include a metal, a metal complex, a metal oxide, a metal selenide, a metal telluride, or a metal sulfide. Specific examples of materials include, but are not limited to, Au, Ag, Cu, Ru, Pt, Ni, Pd, Ti, Bi, Zn, a combination thereof, or an alloy thereof. Other examples include, but are not limited to, titanium oxide (e.g., TiO₂), bismuth oxide (e.g., Bi₂O₃), cerium oxide (e.g., CeO₂), tungsten oxide (e.g., WO₃), bismuth sulphide (e.g., Bi₂S₃), zinc oxide (e.g., ZnO), lead oxide (e.g., PbO), iron oxides (Fe₂O₃, Fe₃O₄), zincsulphide (e.g., ZnS), lead sulphide (e.g., PbS), cadmium sulphide (e.g., CdS), cadmium selenide (e.g., CdSe), and cadmium telluride (e.g., CdTe). The catalyst can include one or more dopants. The catalyst can be a metal oxide or metal hydroxide or metal oxyhydroxide. The dopant can include nitrogen, iodine, fluorine, iron, cobalt, copper, zinc, aluminum, gallium, indium, tungsten, cerium, lanthanum, gold, silver, palladium, platinum, aluminum oxide, and/or cerium oxide.

The method can further include cross-linking the composite, heating the composite, associating the nanoparticle with a support, or irradiating the composite.

The composite can include more than one polymer molecule.

The method can further include forming a solution comprising a solvent and a polymer dissolved in the solvent. The method can further include contacting the precursor moiety to the solution. The precursor moiety can include a metal-containing salt or an organo-metallic compound.

The nanoparticle can have an average particle size of approximately 1 nm to approximately 50 nm.

The method can further include catalyzing a reaction with the nanoparticle. The reaction can be photocatalyzed. The reaction can be photocatalyzed with visible light.

In another aspect, the invention features a composition, including a doped semiconductor nanoparticle and a polymer.

Embodiments may include one or more of the following features. The polymer is a polyelectrolyte. The nanoparticle includes titanium oxide. The nanoparticle includes bismuth oxide. The nanoparticle has a diameter of less than 10 nm.

In another aspect, the invention features a composition, including a nanoparticle and a polymeric support.

Embodiments may include one or more of the following features. The polymer includes a cationic polyelectrolyte. The polymer includes an anionic polyelectrolyte. The polymer includes both a cationic polyelectrolyte and an anionic polyelectrolyte. The nanoparticle includes a semiconductor. The nanoparticle includes a doped semiconductor.

In another aspect, the invention features a method, including adding a flocculating agent to a solution including a polyelectrolyte-stabilized nanoparticle composite.

Embodiments may include one or more of the following features. The composite includes semiconductor nanoparticles. The composite includes doped semiconductor nanoparticles. The flocculating agent includes a polymer that is oppositely charged to the polyelectrolyte in the composite. The flocculating agent includes a counter-ion that is oppositely charged to the polyelectrolyte in the composite. The flocculating agent includes a polyelectrolyte-stabilized nanoparticle composite.

Embodiments may further include one or more of the following features or advantages.

The catalytic systems can provide small catalysts with large active surface areas. In some embodiments, particularly when the catalysts are immobilized on a solid support, the catalytic systems can provide enhanced selectivity, efficiency, recoverability, and/or recyclability.

The catalytic systems (e.g., including doped semiconductor nanoparticles) can provide enhanced photocatalytic activity in the presence of visible wavelengths and ultraviolet wavelengths. For example, the catalytic systems can be used to decompose organic molecules that are models for exterior or interior organic pollutants.

The catalytic systems can withstand high temperature applications (such as catalytic conversion) without adverse effects (such as sintering).

Other aspects, features and advantages will be apparent from the following description of the embodiments and from the claims.

### BRIEF DESCRIPTION OF DRAWINGS

FIG. 1 is an illustration of an embodiment of a catalytic system.

FIG. 2 is a flowchart of an embodiment of a method of making a catalytic system.

FIG. 3 is an X-ray photoelectron spectroscopy (XPS) spectrum of nitrogen-doped titanium oxide nanoparticles.

FIG. 4 is an absorbance spectrum of methylene blue in undoped and doped titanium oxide nanoparticles over a time period of 45 minutes.

FIG. 5 is a scanning electron microscopy (SEM) photograph of gold nanocatalysts on a calcium carbonate support.

FIG. 6 is a powdered X-ray diffraction pattern of titanium oxide nanoparticles.

FIG. 7 is a transmission electron microscopy photograph of titanium oxide/PAAnanoparticles.

FIG. 8 is a transmission electron microscopy photograph of bismuth oxide/PSSnanoparticles.

FIG. 9 is a transmission electron microscopy photograph of gold/PDDA nanoparticles.

FIG. 10 is a plot of absorbance vs. wavelength that shows decolorization of methylene blue by doped bismuth oxide under visible light.

FIG. 11 are photographs that show degradation of soot over 60 minutes, showing the support alone (left), an undopedphotocatalyst (middle), and a doped photocatalyst (right).

### DETAILED DESCRIPTION OF EMBODIMENTS

### Compositions

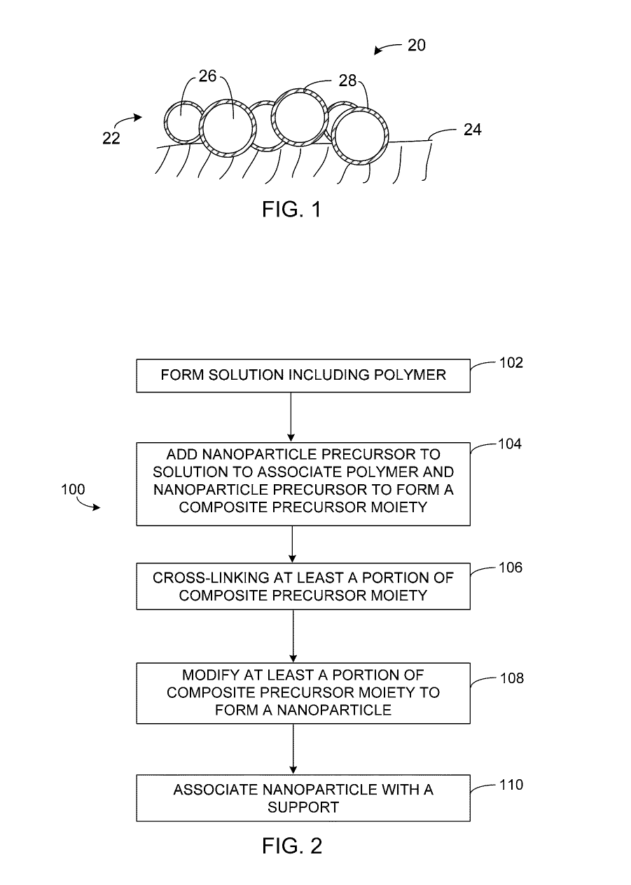

FIG. 1 shows a catalytic system 20 including catalytic nanoparticles 22 carried by a solid support 24. As shown, each catalytic nanoparticle 22 includes a nanocatalyst 26, and a collapsed polymer 28 encapsulating the nanocatalyst. Nanoparticles 22 can have an average width or diameter from approximately 1 nm to approximately 50 nm. As described below, catalytic system 20 can be formed by forming a dilute solution including polymer 28 such that the polymer is in a configuration that allows the polymer to closely associate with a nanoparticle precursor, adding the nanoparticle precursor to the solution under conditions that cause the nanoparticle precursor and/or the polymer to associate with each other to form a composite precursor moiety including the nanoparticle precursor and the polymer, cross-linking at least a portion of the polymer of the composite precursor moiety, and modifying at least a portion of the composite precursor moiety to form polymer-stabilized nanoparticle 22. In some embodiments, polymer-stabilized nanoparticle 22 is associated with support 24.

As used herein, the term “precursor moiety” refers to a compound or entity at least a portion of which is a component of the eventual nanoparticle formed and includes nanoparticle precursors.

Nanocatalyst 26 can include (e.g., be formed solely of) any material capable of having catalytic activity (e.g., but is not limited to, photocatalytic activity) in a reaction to which catalytic system 20 is applied. Nanocatalyst 26 can include a metallic conductor and/or a semiconductor. Examples of materials that can be included in nanocatalyst 26 include elemental (i.e., formally zero valent) metals, metal alloys, and/or metal-containing compounds (e.g., metal complexes, metal oxides, and metal sulphides). Specific examples of materials include, but are not limited to, Au, Ag, Cu, Ru, Pt, Ni, Pd, Ti, Bi, Zn, a combination thereof, or an alloy thereof. Other examples include, but are not limited to, titanium oxide (e.g., TiO₂), bismuth oxide (e.g., Bi₂O₃), cerium oxide (e.g., CeO₂), tungsten oxide (e.g., WO₃), bismuth sulphide (e.g., Bi₂S₃), zinc oxide (e.g., ZnO), lead oxide (e.g., PbO), iron oxides (Fe₂O₃, Fe₃O₄), zincsulphide (e.g., ZnS), lead sulphide (e.g., PbS), cadmium sulphide (e.g., CdS), cadmium selenide (e.g., CdSe), and cadmium telluride (e.g., CdTe). Identification of the crystal structure of the catalyst can be made using powder X-ray diffraction.

In some embodiments, the material(s) included in nanocatalyst 26 includes one or more dopants. The dopant can be used, for example, to modify the electronic properties of nanocatalyst 26. For example, while semiconducting titanium oxide can adequately photocatalytically dissociate organic pollutants in the presence of ultraviolet light, doping the semiconductor with certain elements or ions can make the semiconductor photocatalytic under visible light and more versatile. Examples of dopants include nonmetal compounds, metal compounds, nonmetal atoms, metal atoms, nonmetal ions, metal ions, and combination thereof. Specific examples of dopants include, but are not limited to, nitrogen, iodine, fluorine, iron, cobalt, copper, zinc, aluminum, gallium, indium, tungsten, lanthanum, gold, silver, palladium, platinum, aluminum oxide, and cerium oxide. Examples of doped materials include doped bismuth materials (e.g., bismuth oxide doped with nitrogen, iodine, fluorine, zinc, gallium, indium, lanthanum, and/or aluminum oxide), doped titanium materials (e.g., titanium oxide doped with nitrogen, iodine, fluorine, metal ions, zero valent metals, and/or oxides such as metal oxides (e.g., zinc oxide), aluminum oxide, and silicon oxide). Dopants can be in a range of approximately 1-10 mol %, approximately 0.1-1 mol %, or approximately 0.01-0.1 mol %.

Catalytic system 20 can include nanocatalysts 26 of the same composition or different compositions. Within one catalytic system 20, all the nanocatalysts 26 can have the same composition, or alternatively, some nanocatalysts can have a first composition, while other nanocatalysts can have a second composition different from the first composition. Nanocatalyst 26 can include two or more different catalytic compositions, e.g., titanium oxide and zinc oxide.

Polymer 28 can include natural polymers and/or synthetic polymers. Polymer 28 can be homopolymers or copolymers of two or more monomers, including block copolymers and graft copolymers. Examples of polymers 28 include materials derived from monomers such as styrene, vinyl naphthalene, styrene sulphonate, vinylnaphthalenesulphonate, acrylic acid, methacrylic acid, methylacrylate, acrylamide, methacrylamide, acrylates, methacrylates, acrylonitrile, and N-lower alkyl acrylamides.

In some embodiments, polymer 28 includes a polyelectrolyte. A “polyelectrolyte” refers to a polymer that contains ionized or ionizable groups. The ionized or ionizable groups can be cationic or anionic. Examples of cationic groups include amino and quaternary ammonium groups, and examples of anionic groups include carboxylic acid, sulfonic acid and phosphates. The polyelectrolytes can be homopolymers, random polymers, alternate polymers, graft polymers, or block copolymers. The polyelectrolytes can be synthetic or naturally occurring. The polyelectrolytes can be linear, branched, hyper branched, or dendrimeric. Examples of cationic polymers include, but are not limited to, poly(allylamine hydrochloride) (PAAH), and poly(diallydimethylammonium chloride) (PDDA). Examples of anionic polymers include, but are not limited to, polyacrylic acid (PAA), poly(methacrylic acid), poly(sodium styrene sulfonate) (PSS), and poly(2-acrylamido-2-methyl-1-propane sulphonic acid) (PAMCS). In some embodiments, polymer 28 includes a biopolymer, such as carboxymethylcellulose, chitosan, and poly(lactic acid). See, for example, U.S. Pat. Nos. 7,501,180 and 7,534,490, the entire contents of both are herein incorporated by reference.

In some embodiments, the polymer (e.g., the polyelectrolyte) has a high molecular weight. For example, the molecular weight can be greater than or equal to approximately 50,000 D, greater than or equal to approximately 100,000 D, or greater than or equal to approximately 200,000 D.

In addition to providing catalytic system 20 with selectivity and recyclability, a feature of providing nanocatalysts 26 on support 24 is the ability to shape the support into a desired shape. Support 24 can be shaped according to a particular application. Materials of constructions for the support 24 can also be selected according to a particular application.

In certain embodiments, catalytic system 20 is substantially free of a support carrying catalytic nanoparticles 22.

### Syntheses

FIG. 2 shows a method 100 of making catalytic system 20. Briefly, method 100 includes (a) forming a solution including a polymer (such as a polyelectrolyte) such that the polymer is in a configuration that allows the polymer to closely associate with a nanoparticle precursor (Step 102), (b) adding the nanoparticle precursor to the solution under conditions that cause the nanoparticle precursor and/or the polymer to associate with each other to form a composite precursor moiety including the nanoparticle precursor and the polymer (Step 104), (c) optionally cross-linking at least a portion of the polymer of the composite precursor moiety (Step 106), and (d) modifying at least a portion of the composite precursor moiety to form a polymer-encapsulated nanoparticle (Step 108). In some embodiments, the polymer-encapsulated nanoparticle can also be associated with (e.g., attached to) a support (Step 110). In some embodiments, more than one polymer molecule is associated with the nanoparticle precursor in step (b). In some embodiments, step (c) is replaced with an irradiation step using high-energy radiation such as UV, gamma, or other actinic radiation. This irradiation step can cause scission of the polymer of the composite precursor moiety, causing the composite precursor moiety to include multiple polymer molecules.

The solution including the polymer can be formed (Step 102) by dissolving one or more selected polymers 28 (e.g., polyelectrolytes) in a solvent. The solvent can include any compositions capable of dissolving the polymer(s). The solvent can include an organic solvent (e.g., alkanols, ketones, amines, and dimethylsulfoxide) and/or an inorganic solvent (e.g., water). The solvent can include two or more different compositions. As examples, polymers with ionizable groups, such as NH₂, RNH, and COOH, can be chosen because of their water-solubility under appropriate solution conditions and their ability to undergo a collapse transition (described below) when exposed to certain concentrations of ions in solution, for example, through addition of an inorganic salt.

As indicated above, the polymer in the solution is in a configuration that allows the polymer to closely associate with a nanoparticle precursor. Briefly, the conformation of a polymer in solution is dictated by various conditions of the solution, including its interaction with the solvent, its concentration, and the concentration of other species that may be present. The polymer can undergo conformational changes depending on the pH, ionic strength, temperature and concentration. For polyelectrolytes, at high charge density, e.g., when “monomer” units of the polymer are fully charged, an extended conformation is adopted due to electrostatic repulsion between similarly charged monomer units. Decreasing the charge density of the polymer, either through addition of salts and/or a change of pH, can result in a transition from extended polymer chains to a more tightly-packed globular, collapsed conformation. This collapse transition is driven by attractive interactions between polymer segments that override the electrostatic repulsion forces at sufficiently small charge densities. A similar transition can be induced by changing the solvent environment of the polymer. This collapsed polymer is a nanoparticle with nanometer-scale dimensions having approximately globular form, generally as a spheroid, but the collapsed polymer can also have an elongate or multi-lobed conformation with nanometer-scale dimensions.

Next, a nanoparticle precursor is added to the polymer solution described above under conditions that cause the nanoparticle precursor and/or the polymer to associate with each other to form a composite precursor moiety including the nanoparticle precursor and the polymer (Step 104). In particular, during the association, at least a portion of the polymer is collapsed about the nanoparticle precursor, which serves as a precursor moiety. “Precursor moiety” refers to a compound or entity at least a portion of which is a component of the eventual nanoparticle formed. Examples of nanoparticle precursors include metal complexes (e.g., organo-metallic compounds), metal salts, organic ions, inorganic ions, or combinations thereof. For example, the precursor moiety can include an ion of an organic salt or an inorganic salt, such as one having the formula MₓA_{y}, where M is a Group I to IV metal cation possessing a +y charge, and A is the counter ion to M with a −x charge, or a combination thereof. Specific examples include bismuth nitrate, titanium(IV) bis(ammonium lactato) dihydroxide, chloroauric acid (HAuCl₄), and zinc nitrate. Multiple precursor moieties can be used.

In embodiments in which catalytic nanoparticles 22 are doped, one or more selected dopant sources containing the selected dopant(s) are also added to the polymer solution. Examples of dopant sources include, but are not limited to, iodic acid (an iodine source), ammonium fluoride (a fluorine source), aluminum nitrate (an aluminum source), zinc nitrate (a zinc source), auric acid (a gold source), urea (a nitrogen source), gallium nitrate (a gallium source), indium nitrate (an indium source), and/or lanthanum nitrate (a lanthanum source).

The addition to the solution of the nanoparticle precursor or precursor moiety, which can act as a collapsing agent, induces collapse of the polymer to substantially surround and confine at least a portion of added the precursor moiety. “Confined” means that the nanoparticle is substantially within the limits of the dimensions of the collapsed polymer and includes, but is not limited to, the situation wherein portions of the polymer may be strongly interacting with the nanoparticle within the dimensions of the polymer. As a result of the collapse of the polymer, a composite precursor moiety including the encapsulating polymer and the confined nanoparticle precursor is formed. Alternatively or additionally, other techniques can be used to collapse the polymer around the nanoparticle precursor. For example, a collapsing agent, such as a different solvent, an ionic species (e.g., a salt), or combinations thereof can be added to induce collapse of the polymer. Multiple collapsing agents can be used.

Collapse of the polymer can be monitored using viscometry. Typically, solutions of polymers show a viscosity higher than that of the solvent in which the polymers are dissolved. For polyelectrolytes, in particular, the polymeric solution can have a very high viscosity, such as a syrupy consistency. After the polymer has collapsed to form the composite precursor moiety, a well-dispersed sample of the composite precursor moiety can exhibit a viscosity much lower than before the polymer had collapsed. This decreased viscosity, after and even during collapse, can be measured under appropriate conditions with a vibro-viscometer or an Ostwald viscometer.

Formation of nanoparticles can be demonstrated using dynamic light scattering (DLS) or transmission electron microscopy (TEM). In DLS, formation of nanoparticles is demonstrated by detection of a monomodal or multimodal scattering source at the nanoscale. In TEM, the nanoparticles can be visualized directly.

In some embodiments, the composite precursor moiety has a mean diameter of from approximately 1 nm to approximately 100 nm.

After the polymer has collapsed and a composite precursor moiety has formed, the collapsed conformation for the polymer can optionally be retained and/or made permanent by intra-molecular cross-linking the polymer or forming intra-molecular bonds (Step 106). Cross-linking can provide the composite precursor moiety favorable solubility and non-aggregative properties. Cross-linking can include hydrogen bond formation, chemical reaction to form new bonds, and/or coordination with multivalent ions. Cross-linking can occur on a surface layer, at a specific location within the collapsed nanoparticles, and/or across the entire composite precursor moiety. Cross-linking can be performed using chemicals and/or radiation. For example, the polymer can be exposed to ultraviolet (UV) radiation (such as from a UV lamp or a UV laser). If radiation is used, the radiation can additionally cause scission in the polymer, producing multiple polymer molecules from a single polymer molecule. Alternatively or additionally, intra-molecular cross-links can be chemically produced, for example, using carbodiimide chemistry with a homobifunctional cross-linker.

In some embodiments, the collapsed intra-molecular, cross-linked polymer have some of the ions from an inorganic salt confined within the collapsed structure for forming the composite nanoparticle. The confined ions, for example, can be reduced, oxidized, and/or reacted (e.g., by precipitation with an external agent), which results in the formation of the composite nanoparticle having an inner nanoparticle confined within the collapsed intra-molecular cross-linked polymeric material. Un-reacted ionizable groups can serve as future sites for further chemical modification, dictate the particles solubility in different media, or both.

After at least a portion of the polymer is cross-linked, at least a portion of the precursor moieties of the composite precursor moiety is modified (Step 108) to form nanoparticle 22. Modification can include heating the composite precursor moiety to a temperature high enough to cause modification of the precursor, but not too high as to cause complete degradation of the polymer stabilizer. If the modification step is, e.g. hydrolysis, the system is heated to a high enough temperature to cause hydrolysis of the precursor. Alternately, if a decomposition of the precursor is involved, the system is heated to a high enough temperature to cause decomposition. The system is heated for a sufficiently long time to allow the majority of the precursor to be modified. In some embodiments, in order to decrease the rate of polymer degradation, the heating process takes place under an inert atmosphere or at elevated pressures. In other embodiments, the modification can include changing the pH of the solution, to cause, e.g. hydrolysis of the precursor. The pH change is chosen to effect decomposition or modification of the precursor to form the nanoparticle without destroying the polymer stabilizer.

In some embodiments, nanoparticle 22 has a mean diameter in the range from approximately 1 nm to approximately 100 nm. The mean diameter, provided here is not meant to imply any sort of symmetry (e.g., spherical, ellipsoidal, etc.) of the composite nanoparticle. Rather, the nanoparticles can be highly irregular and asymmetric.

In embodiments in which catalytic system 20 includes support 24, catalytic nanoparticles 22 are attached to the support (Step 110). For example, the nanoparticles 22 can be mixed with support 24 in a solvent for a sufficient time for the support to carry the nanoparticles. The resulting product can be treated to help affix nanoparticles 22 to support 24. In some embodiments, nanoparticle 22 can be chemically affixed on support 24 via one or more functional groups of the polymer or support.

In other embodiments, support 24 includes nanoparticles 22 themselves. For example, a solution containing at least one type of negatively charged polyelectrolyte can be mixed with a solution containing at least one type of positively charged polyelectrolyte, wherein at least one of the two solutions also includes nanoparticles 22 formed previously. The resulting polymer-encapsulated nanoparticles 22 can form a floc including nanocatalysts on a solid support that can be dried. More specifically, a nanocatalyst encapsulated by a negatively charged polyelectrolyte (such as polyacrylic acid (PAA), poly(methacrylic acid), poly(sodium styrene sulfonate) (PSS), or poly(2-acrylamido-2-methyl-1-propane sulphonic acid) (PAMCS)) can be reacted with a nanocatalyst encapsulated by positively charged polyelectrolyte (such as poly(allylamine hydrochloride) (PAAH), or poly(diallydimethylammonium chloride) (PDDA)) to form a floc. The polymers can also include biopolymers, such as chitosan, carboxymethylcellulose, alginate, poly(lactic acid), and the like. Other methods to produce a nanoparticle floc include adding a large amount of counter ions to a solution containing nanoparticles 22, or otherwise precipitating nanoparticles 22 out of solution, e.g., by adding a non-solvent or by forming a salt.

### Applications

Catalytic system 20 can be used in any application in which the system can catalyze one or more selected reactions. For example, catalytic system 20 can be used for heterogeneous catalysis where catalytic nanoparticles 22 can interact with gas-phase and/or liquid-phase molecules. Reactions in which catalytic system 20 can be used include, for example, organic reactions, degradation of various organic materials, degradation of various inorganic materials, physiological reactions, reactions with microorganisms, redox reactions (e.g., involving metals), selective oxidation reactions, selective reduction reactions, acid-base catalyzed reactions, various coupling reactions including carbon-carbon bonds, and conversion of organic and/or inorganic pollutants in different media. For example, gold nanocatalysts on a metal oxide support can efficiently mediate selective (e.g., more than approximately 80%) hydrogenation of aromatic nitro compounds. Additional examples are given below.

Catalytic system 20 can be applied to photocatalysis that uses ultraviolet light and/or visible light. In this specification, “photocatalysis” is understood to mean a chemical reaction that requires the presence of light mediated by an inorganic species (the “photocatalyst”), such as inorganic semiconductors. In some embodiments, where breakdown of organics is desired, photocatalysis is understood to encompass all forms of photodegradation of the organics that are accelerated, enabled or enhanced by the presence of the photocatalyst. In some embodiments, photocatalysts remove contaminants from a surface by a modification of their surface chemistry caused by exposure to light. For example, the photocatalyst can be used for air purification, water purification, decomposition of organic pollutants, and/or clean up of industrial effluents (such as those that contain organic dyes). But many photocatalysts are not effective under visible light. By providing a photocatalyst that can be effective or more active under visible light (λ>350 nm), weak illumination (such as interior light) and ultraviolet light, the usefulness of the photocatalyst can be increased.

One approach to enhancing the photocatalytic activity of a semiconducting photocatalyst is to change the electronic properties of the photocatalyst by including one or more dopants. For example, the activity of nitrogen-doped polyelectrolyte-encapsulated titanium oxide nanoparticles in the degradation of organic dyes (e.g., methylene blue) can be enhanced. As shown below in Example 5A, both nitrogen-doped and undoped polyelectrolyte-encapsulated titanium oxide nanoparticles were added to a 2 mM methylene blue solution, and then subjected to visible light. Within 30 minutes, the solution containing the doped nanoparticles became colorless, which indicates photodegradation of the methylene blue, but the solution containing undoped nanoparticles retained the characteristic blue color of methylene blue. In Example 5B, the photodegradation of oxalic acid was demonstrated under visible light using both doped and undoped polyelectrolyte-encapsulated titanium oxide nanoparticles. The rate of degradation/bleaching was more in the case of nitrogen-doped polyelectrolyte-encapsulated titanium oxide than for the undoped nanoparticles. These experiments show that the nitrogen-doped titanium oxide nanoparticles can be more efficiently photocatalytic under visible light compared to the undoped titanium oxide nanoparticles.

Polyelectrolyte-encapsulated semiconductor nanoparticles can also be used to degrade organic soot (a pollutant) in the presence of visible light. Both doped and undoped polyelectrolyte-encapsulated titanium dioxide nanoparticles were applied to different regions of a ceramic brick tile. The tile was then subjected to an organic soot flow, which deposited a black organic soot on top of the nanoparticles. The soot and nanoparticle-covered tiles were then subjected to sunlight and moisture for approximately 30 minutes. After washing with water, the surface covered with doped titanium oxide nanoparticles became clean while the surface covered with the undoped titanium dioxide nanoparticles showed little change.

In other examples, doped and undoped bismuth oxide nanoparticles were used to degrade methylene blue and oxalic acid under visible light. More specifically, polyelectrolyte-encapsulated bismuth oxide nanoparticles and polyelectrolyte-encapsulated bismuth oxide nanoparticles doped with iodine, nitrogen and aluminum were added to a 2 mM methylene blue solution, and then subjected to visible light. Within 30 minutes, the solution containing the doped nanoparticles became colorless, which indicates photodegradation of methylene blue, but the solution containing the undoped nanoparticles retained the characteristic blue color of methylene blue. The above experiments show that the iodine, nitrogen and aluminum doped polyelectrolyte-encapsulated bismuth oxide nanoparticles were more efficient photocatalysts under visible light compared to the undoped bismuth oxide nanoparticles.

In addition to photocatalysis, catalytic system 20 can be applied to catalytic conversion, such as in automotive applications. For example, similar to some noble metals that can oxidize certain volatile organic compounds and carbon oxides, and reduce nitrogen oxide, certain catalytic systems 20 can be used to degrade various volatile organic compounds (e.g., pollutants) and/or to reduce nitrogen oxides. Furthermore, catalytic systems 20 (such as polymer-encapsulated gold nanoparticles supported on cerium oxide) can be an effective catalytic converter at high temperatures (e.g., with reduced adverse effects such as sintering), and at low temperatures. Catalytic system 20 (such as polymer-encapsulated palladium nanoparticles supported on cerium oxide) can be used in cross-coupling reactions.

The following examples are illustrative and not intended to be limiting.

### EXAMPLES

### 1. Collapsing of Nanocatalyst with a Negatively Charged Polyelectrolyte

1A. Preparation of Encapsulated Bismuth Oxide Nanoparticles Using High Molecular Weight Poly(Sodium Styrene Sulphonate) (PSS):

This example shows a method of producing polymer-encapsulated bismuth oxide (a semiconductor) nanoparticles. The method includes (a) dissolving a polymer (e.g., polyelectrolyte) in an aqueous solution under solution conditions that render the polymer in a configuration that would allow the polymer to closely associate with a nanoparticle precursor (e.g., a bismuth-containing precursor), (b) adding the nanoparticle precursor to the solution under conditions that cause the nanoparticle precursor to associate with the polymer, and (c) modifying the nanoparticle precursor to make nanoparticles stabilized by the polymer (e.g., bismuth oxide nanoparticles stabilized by the polyelectrolyte).

In a first beaker, 0.0724 grams (0.149 mmole) of bismuth nitrate was dissolved in 2 ml concentrated 70% nitric acid (15.6M), and this solution was diluted to 100 ml with deionised water. This bismuth nitrate solution was added slowly with constant stirring to a second beaker containing 200 ml of 2 milligrams/ml PSS (M_{w}=1,000,000) solution. The resulting solution was then irradiated with ultraviolet (UV) light from a 254-nm wavelength UV lamp for 2 hours, during which, the color changed from colorless to yellow.

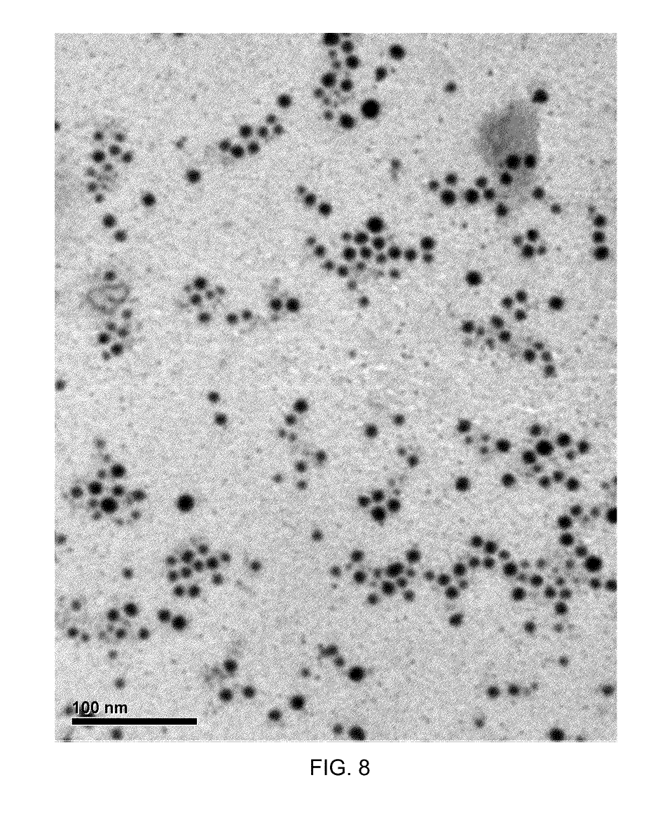

A 10M sodium hydroxide solution was added to the UV treated solution to bring the pH to 10.8, at which point, the color of the solution changed to deep orange. This solution was further stirred for 2 hours over warm water (70° C.). Next, the solution was concentrated to 50 ml using a rotary evaporator. Then, the solution was precipitated using a 3M sodium chloride solution and 95% ethanol. The color of the precipitate was orange-brown. The precipitate was washed with 70% ethanol twice and then dried in air—a transmission electron microscopy image is shown in FIG. 8.

1B. Preparation of Encapsulated Bismuth Sulphide Nanoparticles Using High Molecular Weight Poly(Sodium Styrene Sulphonate) (PSS):

This example is similar to Example 1A above and shows that where the polymer includes a sulfur-containing group (such as poly(styrene sulfonate)), the nanoparticle composite can be heated under appropriate conditions to form a sulfide nanoparticle (e.g., bismuth sulfide nanoparticles).

In a first beaker, 0.0724 grams (0.149 mmole) of bismuth nitrate was dissolved in 2 ml concentrated 70% nitric acid (15.6M), and this solution was diluted to 100 ml with deionised water. This bismuth nitrate solution was added slowly with constant stirring to a second beaker containing 200 ml of 2 mg/ml PSS (M_{w}=1,000,000) solution. The resulting solution was then irradiated with ultraviolet (UV) light from a 254-nm wavelength UV lamp for 2 hours, during which, the color changed from colorless to yellow.

A 10M sodium hydroxide solution was added to the UV treated solution to bring the pH to 10.8, at which point, the color of the solution changed to deep orange. This solution was further stirred for 2 hours over warm water (70° C.). Next, the solution was concentrated to 50 ml using a rotary evaporator. Then, the solution was precipitated using a 3M sodium chloride solution and 95% ethanol. The color of the precipitate was orange-brown. The precipitate was washed with 70% ethanol twice and then dried in air. The dried precipitate was then heated in a glass furnace under vacuum at 400° C. for 2 hours. The final color of the precipitate was dark brown.

1C. Preparation of Encapsulated Titanium Oxide Nanoparticles Using High Molecular Weight Polyacrylic Acid (PAA):

This example shows a method for producing polymer-encapsulated, catalytic titanium oxide nanoparticles. The method includes (a) dissolving a polymer into an aqueous solution under solution conditions that render the polymer in a configuration that would allow the polymer to closely associate with a nanoparticle precursor (e.g., a titanium-containing complex), (b) adding the nanoparticle precursor to the solution under conditions that cause the nanoparticle precursor to associate with the polymer, and (c) modifying the nanoparticle precursor to make a nanocatalyst.

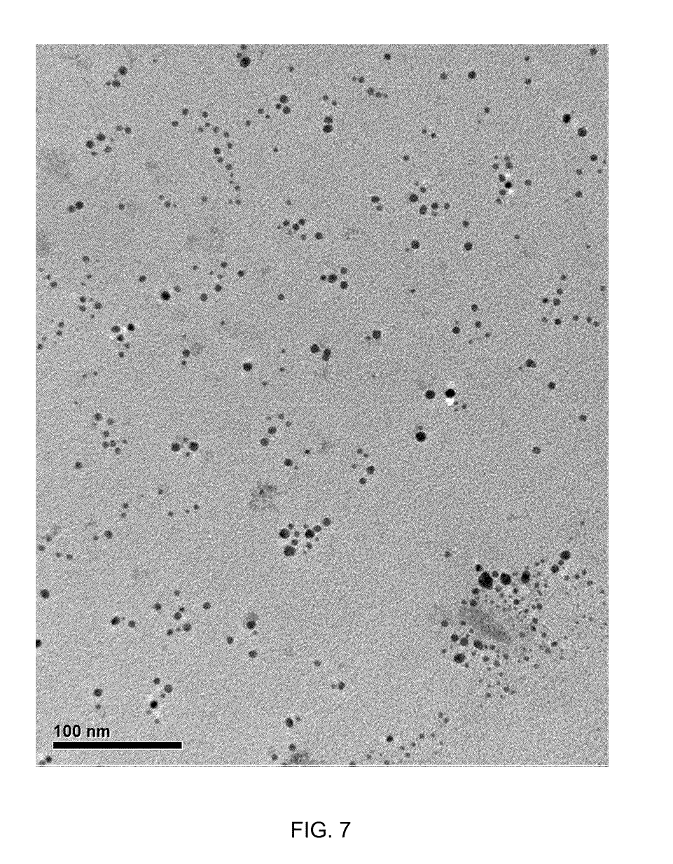

100 ml of 2 mg/ml PAA (M_{w}=1,250,000) with 5 weight % poly(sodium styrene sulphonate) was neutralized to pH 6.8 using a 0.5N aqueous sodium hydroxide solution. To this solution, 360 microlitre of 50 wt % commercial titanium(IV) bis(ammonium lactato) dihydroxide in water, diluted with 100 ml of water, was added dropwise with vigorous stirring. After the addition was completed, the solution was irradiated with UV light from a 254-nm wavelength UV lamp for 2 hours, and then a 0.5M sodium hydroxide solution was added to bring the pH to 10. The solution was stirred for another hour. The solution was then concentrated to 70 ml and precipitated using a 3M sodium chloride solution and 95% ethanol. The precipitate was washed three times with 70% alcohol and then dried. The color of the dried precipitate as very light yellow. The powder X-ray diffraction pattern is shown in FIG. 6, and a transmission electron microscopy image is shown in FIG. 7.

1D. Preparation of Encapsulated Gold Nanoparticles Using High Molecular Weight Polyacrylic Acid (PAA):

This example shows a method for producing polymer-encapsulated, catalytic gold nanoparticles. The method includes (a) dissolving a polymer into an aqueous solution under solution conditions that render the polymer in a configuration that would allow the polymer to closely associate with a nanoparticle precursor (e.g., a gold-containing compound), (b) adding the nanoparticle precursor to the solution under conditions that cause the nanoparticle precursor to associate with the polymer, and (c) modifying the nanoparticle precursor to make a nanocatalyst.

250 ml of 1 mg/ml PAA (M_{w}=1,250,000) with 5 weight % poly(sodium styrene sulphonate) was neutralized to pH 6.8 using a 0.5N aqueous sodium hydroxide solution. To this solution, 39.5 milligrams of chloroauric acid (HAuCl₄) in 125 ml of deionized water was added at a rate of 2 ml/minute with vigorous stirring. After the addition was completed, 40.6 milligrams of sodium borohydride (NaBH₄) was added in one lot, and the solution was stirred for another hour. At this point, the color of the solution was red. The solution was then irradiated with UV light from a 254-nm wavelength UV lamp for two hours. The solution was then concentrated to 70 ml and precipitated using a 3M sodium chloride solution and 95% ethanol. The precipitate was washed three times with 70% alcohol and then dried. The resulting product was a red powder.

1E. Preparation of Encapsulated Zinc Oxide Nanoparticles Using Low Molecular Weight Polyacrylic Acid (PAA):

This example shows a method for producing a catalytic zinc oxide nanoparticle. The method includes (a) dissolving a low molecular weight polymer in an aqueous solution under solution conditions that render the polymer in a configuration that would allow the polymer to closely associate with a nanoparticle precursor and (b) adding the nanoparticle precursor to the solution under conditions that cause the nanoparticle precursor to associate with the polymer, and (c) modifying the nanoparticle precursor to make nanocatalysts stabilized by the polymer.

In a first beaker, 0.3245 grams (5 mmole) of zinc nitrate was dissolved in 100 ml of deionized water. This zinc nitrate solution was added slowly with constant stirring to a second beaker containing 200 ml of 2 milligrams/ml PAA (M_{w}=1800), neutralized to pH 6.8 using a 0.5N aqueous sodium hydroxide solution. A 10M sodium hydroxide solution was added to the stirred solution to bring the pH to 10.8, and the resulting solution was further stirred for 2 hours over warm water (80° C.). Next, the solution was concentrated to 50 ml using a rotary evaporator. Then, the solution was precipitated using a 3M sodium chloride solution and 95% ethanol. The precipitate was white. The precipitate was then washed with 70% ethanol twice and dried in air. The dried precipitate was off-white.

1F. Preparation of Encapsulated Palladium Nanoparticles Using High Molecular Weight Polyacrylic Acid (PAA).

This example shows a method for producing polymer-encapsulated, catalytic palladium nanoparticles. The method includes (a) dissolving a polymer into an aqueous solution under solution conditions that render the polymer in a configuration that would allow the polymer to closely associate with a nanoparticle precursor (e.g., a palladium-containing compound), (b) adding the nanoparticle precursor to the solution under conditions that cause the nanoparticle precursor to associate with the polymer, and (c) modifying the nanoparticle precursor to make a nanocatalyst.

32 ml of 2 mg/ml PAA (M_{w}=1,250,000) with 5 weight % poly(sodium styrene sulphonate) and 18.75 ml deionized water was neutralized to pH 6.8 using a 0.5N aqueous sodium hydroxide solution. To this solution, 22.5 milligrams of palladium chloride (PdCl₂) in 0.5 mL HCl (1M) and 10 ml water, with pH slowly adjusted to 5 with 1M NaOH, was added at a rate of 2 ml/minute with vigorous stirring. After the addition was completed, 40 milligrams of sodium borohydride (NaBH₄) was added in one lot, and the solution was stirred for another hour. At this point, the color of the solution was black. The solution was then irradiated with UV light from a 254-nm wavelength UV lamp for two hours. The solution was then concentrated to 70 ml and precipitated using a 3M sodium chloride solution and 95% ethanol. The precipitate was washed three times with 70% alcohol and then dried. The resulting product was a black powder.

1G. Preparation of Encapsulated Platinum Nanoparticles Using High Molecular Weight Polyacrylic Acid (PAA).

This example shows a method for producing polymer-encapsulated, catalytic platinum nanoparticles. The method includes (a) dissolving a polymer into an aqueous solution under solution conditions that render the polymer in a configuration that would allow the polymer to closely associate with a nanoparticle precursor (e.g., a platinum-containing compound), (b) adding the nanoparticle precursor to the solution under conditions that cause the nanoparticle precursor to associate with the polymer, and (c) modifying the nanoparticle precursor to make a nanocatalyst.

25 ml of 2 mg/ml PAA (M_{w}=1,250,000) with 5 weight % poly(sodium styrene sulphonate) and 25 ml deionized water was neutralized to pH 6.8 using a 0.5N aqueous sodium hydroxide solution. To this solution, 66 milligrams of hydrogen hexachloroplatinate (H₂PtCl₆) dissolved in 25 ml deionized water was added at a rate of 2 ml/minute with vigorous stirring. After the addition was completed, 20 milligrams of sodium borohydride (NaBH₄) was added in one lot, and the solution was stirred for another hour. At this point, the color of the solution was black. The solution was then irradiated with UV light from a 254-nm wavelength UV lamp for two hours. The solution was then concentrated to 70 ml and precipitated using a 3M sodium chloride solution and 95% ethanol. The precipitate was washed three times with 70% alcohol and then dried. The resulting product was a black powder.

### 2. Collapsing of Nanocatalyst with a Positively Charged Polyelectrolyte

These examples are similar to Examples 1C and 1D above in that they show preparation of titanium oxide and gold nanoparticles, however, the polyelectrolyte species in each instance is positively charged.

2A. Preparation of Encapsulated Titanium Oxide Nanoparticles Using Poly(Allylamine Hydrochloride) (PAAH):

To a 200 ml solution of 2 mgs/ml PAAH (M_{w} 60,000), 160 microlitres of 50 wt % commercial titanium(IV) bis(ammonium lactato) dihydroxide, diluted with 200 ml deionized water, was added dropwise with vigorous stirring. After the addition was completed, the solution was irradiated with UV light from a 254-nm wavelength UV lamp for 2 hours, and then a 0.5M sodium hydroxide solution was added to bring the pH to 8. The solution was stirred for another hour. The solution was then concentrated to 70 ml and precipitated using a 1M sodium sulphate solution and 95% ethanol. The precipitate was washed three times with 70% alcohol and then dried.

2B. Preparation of Encapsulated Gold Nanoparticles Using Poly(Diallyldimethyl Ammonium Chloride) (PDDA):

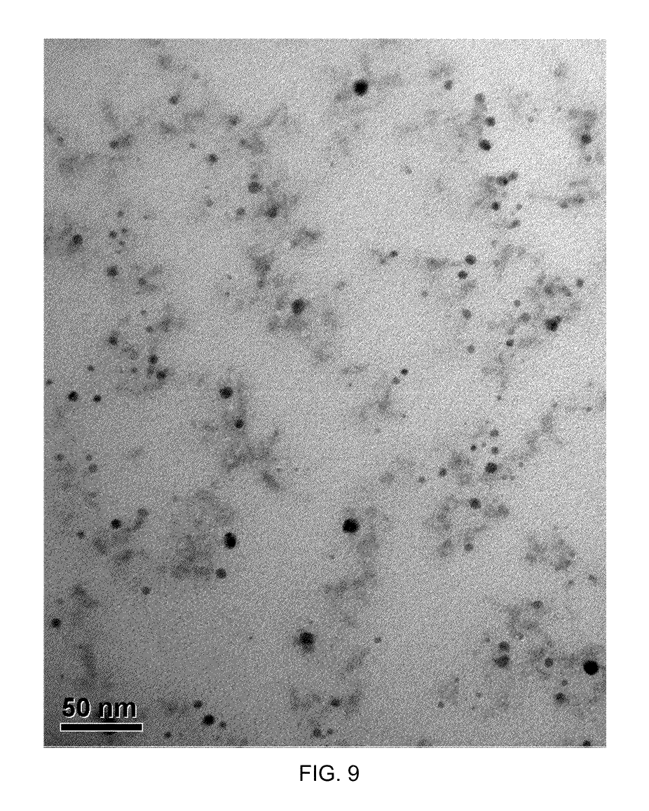

To a 266 ml solution of 1 mg/ml PDDA (M_{w}=450,000), 20 milligrams of chloroauric acid (HAuCl₄) was added at a rate of 10 ml/minute while vigorously stirred. After the addition was completed, 20 milligrams of sodium borohydride (NaBH₄) was added in one lot, and the solution was stirred for another hour. At this point, the color of the solution was deep orange. The solution was then irradiated with UV light from a 254-nm UV lamp for two hours. The solution was then concentrated to 70 ml and precipitated using a 1M sodium sulphate solution and 95% ethanol. The precipitate was washed three times with 70% alcohol and then dried. The final product was a red powder—a transmission electron microscopy image is shown in FIG. 9.

### 3. Doping of Polyelectrolyte Encapsulated Nanocatalyst

3A. Preparation of Encapsulated Gallium-Doped Bismuth Oxide Nanoparticles Using Poly(Sodium Styrene Sulphonate) (PSS):

The nanocatalysts can be doped (e.g., with one or more cations, anions, and/or metal oxides) to modify their electronic properties. This example shows a method for producing doped semiconductor nanoparticles (e.g., doped semiconducting bismuth oxide nanoparticles). The method includes (a) dissolving a polymer (e.g., a polyelectrolyte) into an aqueous solution under solution conditions that render the polymer in a configuration that would allow the polymer to closely associate with a nanoparticle precursor and (b) adding the nanoparticle precursor and one or more dopant sources to the solution under conditions that cause the precursor and the dopant source(s) to associate with the polymer to form a composite precursor moiety, and (c) modifying the precursor to make nanoparticles stabilized by the polymer (e.g., bismuth oxide nanoparticles stabilized by a polyelectrolyte). In certain embodiments, the nanoparticles are heated.

In a first beaker, 0.0724 grams (0.149 mmole) of bismuth nitrate was dissolved in 2 ml concentrated 70% nitric acid (15.6M), and diluted to 100 ml with deionised water. This bismuth nitrate solution and 0.0165 grams of gallium nitrate in 5 ml deionised water were added simultaneously with constant stirring to a second beaker containing 200 ml of 2 milligrams/ml of PSS (M_{w}=1,000,000). The resulting solution was then irradiated with UV light from a 254-nm wavelength UV lamp for 2 hours, during which, the color changed from colorless to yellow.

A 10M sodium hydroxide solution was added to the UV treated solution to bring the pH to 10.8, and at this point, the color of the solution changed to deep orange. The solution was stirred for 2 hours over warm water (70° C.). Next, the solution was concentrated to 50 ml using a rotary evaporator. The solution was then precipitated using a 3M sodium chloride solution and 95% ethanol. The color of the precipitate was orange-brown. The precipitate was washed with 70% ethanol twice and then dried in air. The presence of the gallium dopant was determined though Inductively Coupled Plasma (ICP) analyses of the purified solid.

3B. Preparation of Encapsulated Gallium-Doped Bismuth Sulphide Nanoparticles Using Poly(Sodium Styrene Sulphonate) (PSS):

This example shows a method for producing an gallium doped bismuth sulphide nanoparticle. The method includes (a) providing an aqueous of PSS polymeric solution, (b) collapsing at least a portion of the polymeric material about a bismuth precursor and a dopant precursor (namely, gallium nitrate), (c) exposing the polymeric material of the composite precursor moiety to UV radiation, (d) modifying at least a portion of the precursor moieties of the composite precursor moiety to form bismuth sulphide nanoparticles, and (e) heating the composite nanomaterial (e.g., in a vacuum up to 400° C.).

In a first beaker, 0.0724 grams (0.149 mmole) of bismuth nitrate was dissolved in 2 ml concentrated 70% nitric acid (15.6M), and diluted to 100 ml with deionised water. This bismuth nitrate solution and 0.0165 grams of gallium nitrate in 5 ml deionised water were added simultaneously with constant stirring to a second beaker containing 200 ml of 2 milligrams/ml of PSS (M_{w}=1,000,000). The resulting solution was then irradiated with UV light from a 254-nm wavelength UV lamp for 2 hours, during which, the color changed from colorless to yellow.

A 10M sodium hydroxide solution was added to the UV-treated solution to bring the pH to 10.8. The color of the solution changed to deep orange. The solution was stirred for 2 hours over warm water (70° C.). Next, the solution was concentrated to 50 ml using a rotary evaporator. Then, the solution was precipitated using a 3M sodium chloride solution and 95% ethanol. The color of the precipitate was orange-brown. The precipitate was washed with 70% ethanol twice and then dried in air. The dried sample was then heated in a glass furnace under vacuum at 400° C. for 2 hours. The final product was dark brown. The presence of the gallium dopant was determined though Inductively Coupled Plasma (ICP) analyses of the purified solid.

3C. Preparation of Encapsulated Iodine-Doped Bismuth Oxide Nanoparticles Using Poly(Sodium Styrene Sulphonate) (PSS):

This example shows a method for producing an iodine doped bismuth oxide nanoparticle. The method includes (a) providing an aqueous of PSS polymeric solution, (b) collapsing at least a portion of the polymeric material about a bismuth precursor and a dopant precursor (namely, iodic acid), (c) exposing the polymeric material of the composite precursor moiety to UV radiation, (d) modifying at least a portion of the precursor moieties of the composite precursor moiety to form bismuth oxide nanoparticles, and (e) heating the composite nanomaterial (e.g., in a vacuum up to 400° C.).

In a first beaker, 0.0724 grams (0.149 mmole) of bismuth nitrate was dissolved in 2 ml concentrated 70% nitric acid (15.6M), and diluted to 100 ml with deionised water. The bismuth nitrate solution and 0.002627 grams of iodic acid in 5 ml deionised water were added simultaneously with constant stirring to a second beaker containing 200 ml of 2 milligrams/ml of PSS (M_{w}=1,000,000) solution. The resulting solution was irradiated with UV light from a 254-nm wavelength UV lamp for 2 hours, during which, the color changed from colorless to yellow.

A 10M sodium hydroxide solution was added to the UV-treated solution to bring the pH to 10.8. The color of the solution changed to deep orange. The solution was stirred for 2 hours over warm water (70° C.). Next, the solution was concentrated to 50 ml using a rotary evaporator. Then, the solution was precipitated using a 3M sodium chloride solution and 95% ethanol. The color of the precipitate was orange-brown. The precipitate was washed with 70% ethanol twice and then dried in air. The dried sample was then heated in a glass furnace under vacuum at 400° C. for 2 hours. The presence of the dopant was determined by ICP analysis of the heated product.

3D. Preparation of Encapsulated Iodine-Doped Bismuth Sulphide Nanoparticles Using Poly(Sodium Styrene Sulphonate) (PSS):

This example shows a method for producing an iodine doped bismuth sulphide nanoparticle. The method includes (a) providing an aqueous of PSS polymeric solution, (b) collapsing at least a portion of the polymeric material about a bismuth precursor and a dopant precursor (namely, iodic acid), approximately 10 mole % of bismuth to form a composite precursor, (c) exposing the polymeric material of the composite precursor moiety to UV radiation, (d) modifying at least a portion of the precursor moieties of the composite precursor moiety to form bismuth sulphide nanoparticles, and (e) heating the composite nanomaterial (e.g., in a vacuum up to 400° C.).

More specifically, in a first beaker, 0.0724 grams (0.149 mmole) of bismuth nitrate was dissolved in 2 ml concentrated 70% nitric acid (15.6M), and diluted to 100 ml with deionised water. This bismuth nitrate solution and 0.002627 grams of iodic acid in 5 ml deionised water were added simultaneously with constant stirring to a second beaker containing 200 ml of 2 milligrams/ml of PSS (M_{w}=1,000,000) solution. The resulting solution was then irradiated with UV light from a 254-nm wavelength UV lamp for 2 hours, during which, the color changed from colorless to yellow.

A 10M sodium hydroxide solution was added to the UV-treated solution to bring the pH to 10.8. The color of the solution changed to deep orange. The solution was stirred for 2 hours over warm water (70° C.). Next, the solution was concentrated to 50 ml using a rotary evaporator. Then, the solution was precipitated using a 3M sodium chloride solution and 95% ethanol. The color of the precipitate was orange-brown. The precipitate was washed with 70% ethanol twice and then dried in air. The dried sample was then heated in a glass furnace under vacuum at 400° C. for 2 hours. The final product was dark brown. The presence of the iodine dopant was determined though Inductively Coupled Plasma (ICP) analyses of the purified solid. XRD analysis of the final product showed the presence of Bi₂S₃.

3E. Preparation of Encapsulated Iodine, Nitrogen, Aluminum Composite Doped Bismuth Oxide Nanoparticles Using Poly(Sodium Styrene Sulphonate) (PSS):

This example shows a method for producing a bismuth oxide nanoparticles doped with iodine, nitrogen and aluminum. The method includes (a) providing an aqueous of PSS polymeric solution, (b) collapsing at least a portion of the PSS polymeric material about a bismuth precursor and dopant precursors (namely, iodic acid, urea and aluminum nitrate, each approximately 10 mole % of bismuth) to form a composite precursor moiety, (c) exposing the polymeric material of the composite precursor moiety to UV radiation, (d) modifying at least a portion of the precursor moieties of the composite precursor moiety to form bismuth oxide nanoparticles, and (e) heating the composite nanomaterial (e.g., in a vacuum up to 400° C.).

More specifically, in a first beaker, 0.0724 grams (0.149 mmole) of bismuth nitrate was dissolved in 2 ml concentrated 70% nitric acid (15.6M), and diluted to 100 ml with deionised water. The bismuth nitrate solution, 0.002627 grams of iodic acid in 5 ml deionised water, 0.005601 grams of aluminum nitrate in 5 ml deionised water and 0.000896 grams of urea in 5 ml of deionised water were added simultaneously with constant stirring to a second beaker containing 200 ml of 2 mg/ml of PSS (M_{w}=1,000,000) solution. The resulting solution was then irradiated with UV light from a 254-nm wavelength UV lamp for 2 hours, during which, the color changed from colorless to yellow.

A 10M sodium hydroxide solution was added to the UV-treated solution to bring the pH to 10.8. The color of the solution changed to deep orange. Next, the solution was stirred for 2 hours over warm water (70° C.). The solution was concentrated to 50 ml using a rotary evaporator. Then, the solution precipitated using a 3M sodium chloride solution and 95% ethanol. The color of the precipitate was orange-brown. The precipitate was washed with 70% ethanol twice and then dried in air. The dried sample was then heated in a glass furnace under vacuum at 400° C. for 2 hours. Presence of the nitrogen dopant was determined by carbon-hydrogen-nitrogen (“CHN”) analysis of the heated solid, and the presence of iodine and aluminum dopants were determined from ICP analysis of the purified sample. XRD analysis of the heated solid showed the presence of Bi₂O₃.

3F. Preparation of Encapsulated Iodine, Nitrogen, Alumina Composite Doped Titanium Oxide Nanoparticles Using Polyacrylic Acid (PAA):

This example shows a method for producing a titanium oxide nanoparticles doped with iodine, nitrogen and aluminum. The method includes (a) providing an aqueous of PSS polymeric solution, (b) collapsing at least a portion of the PSS polymeric material about a titanium precursor and dopant precursors (namely, iodic acid, urea and aluminum nitrate) to form a composite precursor moiety, (c) exposing the polymeric material of the composite precursor moiety to UV radiation, (d) modifying at least a portion of the precursor moieties of the composite precursor moiety to form titanium oxide nanoparticles, and (e) heating the composite nanomaterial (e.g., in a vacuum up to 225° C.).

A solution of 100 ml of 2 mg/ml PAA (M_{w}=1,250,000), with 5 weight % poly(sodium styrene sulphonate), neutralized to pH 6.8 using a 0.5N aqueous sodium hydroxide solution was prepared. To the prepared solution, 360 microlitre of titanium bis(dimethyl lactate) dihydroxide 50 wt % in water, diluted with 100 ml of deionized water, 0.005 grams of urea in 10 ml of deionized water, 0.013 grams of iodic acid in 10 ml of deionized water, and 0.028 grams of aluminum nitrate in 10 ml deionized water were added dropwise simultaneously with vigorous stirring. After the addition was completed, the solution was irradiated with UV light from a 254-nm wavelength UV lamp, and then a 0.5M sodium hydroxide solution was added to bring the pH to 10. The solution was stirred for another hour. The solution was then concentrated to 70 ml and precipitated using a 3M sodium chloride solution and 95% ethanol. The precipitate was washed three times with 70% alcohol and then dried. Then the dried precipitate was placed into a glass furnace and heated at 225° C. for 3 hours under nitrogen. The final product was pale yellow. Presence of the nitrogen dopant was determined by CHN analysis of the purified product, and the presence of iodine and aluminum dopants were determined from ICP analysis of the purified sample.

3G. Preparation of Encapsulated Nitrogen-Doped Titanium Oxide Nanoparticles Using Polyacrylic Acid (PAA):

This example shows a method of producing polymer-encapsulated, nitrogen-doped titanium oxide, where urea is used as a nitrogen source. The method includes (a) dissolving a polymer (e.g., a polyelectrolyte) in an aqueous solution under solution conditions that render the polymer in a configuration that allows the polymer to closely associate with a nanoparticle precursor, (b) adding a nanoparticle precursor and a nitrogen source to the solution under conditions that cause the nanoparticle precursor to associate with the polymer, (c) modifying the nanoparticle precursor to make the nanocatalyst, and (d) heating a dried composition in the temperature range of 200-500° C. under nitrogen. Even when step (c) occurs at a low temperature of 250° C., doping with nitrogen has been observed by X-ray photoelectron spectroscopy. Also, the amount of nitrogen source added was found to work within a very large range, anywhere from 10 mol % to 100 mol % of the amount of nanoparticle precursor.

100 ml of 2 mg/ml PAA (M_{w}=1,250,000), with 5 weight % poly(sodium styrene sulphonate), neutralized to pH 6.8 using a 0.5N aqueous sodium hydroxide solution was prepared. To the prepared solution, 360 microlitre of titanium bis(dimethyl lactate) dihydroxide 50 wt % in water, diluted with 100 ml of deionized water and 0.005 grams of urea in 10 ml of deionised water were added dropwise simultaneously with vigorous stirring. After the addition was completed, the solution was irradiated with UV light from a 254-nm wavelength UV lamp and then a 0.5M sodium hydroxide solution was added to bring the pH to 10. The solution was stirred for another hour. The solution was then concentrated to 70 ml and precipitated by a 3M sodium chloride solution and 95% ethanol. The precipitate was washed three times with 70% alcohol and then dried. The dried precipitate was placed into a glass furnace and heated at 225° C. for 3 hours under nitrogen. The final product was pale yellow.

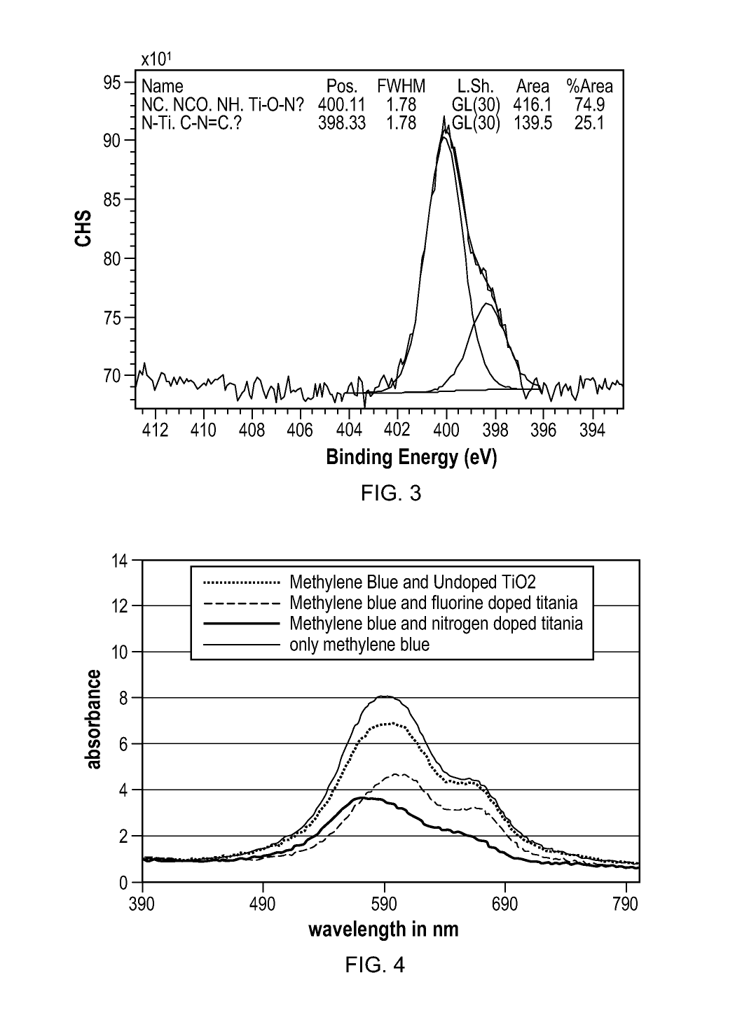

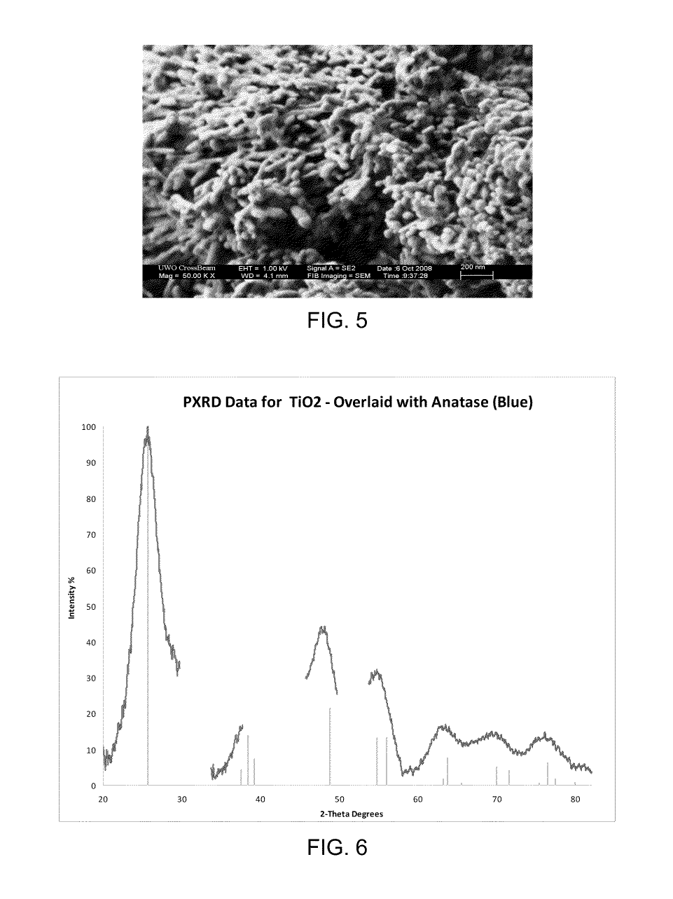

The characteristics of the nitrogen-doped titanium oxide crystal lattice may be examined by X-ray photoemission spectroscopy (XPS). The binding energy of the titanium oxide bonded to the doped nitrogen in the crystal lattice is in the range of 400 eV or less, more particularly, in the range of 396-400 eV. Referring to FIG. 3, an XPS study of the nitrogen-doped titanium oxide produced above shows the binding energy of the is shell of nitrogen atoms is 398.33 eV. As another example, polymer-encapsulated, fluorine-doped titanium oxide can be produced using ammonium fluoride as fluorine source and the procedures described above for nitrogen doping.

3H. Preparation of Encapsulated Tungsten-Doped Bismuth Oxide Nanoparticles Using Poly(Styrene Sulfonic Acid) (PSS):

This example shows a method for producing a bismuth oxide nanoparticles doped with tungsten. The method includes (a) providing an aqueous of PSS polymeric solution, (b) collapsing at least a portion of the PSS polymeric material about a bismuth precursor and dopant precursors (namely, sodium tungstate) to form a composite precursor moiety, (c) exposing the polymeric material of the composite precursor moiety to UV radiation, (d) modifying at least a portion of the precursor moieties of the composite precursor moiety to form bismuth oxide nanoparticles, and (e) heating the composite nanomaterial (e.g., in a vacuum up to 400° C.).

In a first beaker, 0.0724 grams (0.149) of bismuth nitrate was dissolved in 2 ml concentrated 70% nitric acid (15.6M), and diluted to 100 ml with deionised water. 0.01752 grams of sodium tungstate in 5 ml deionised water and the bismuth nitrate solution were added simultaneously under constant stirring to a beaker containing 200 ml of 2 milligrams/ml of PSS (Mw=1,000,000). The resulting solution was then irradiated with UV light from (4) 254-nm wavelength UV lamps for 2 hours, during which, the color changed from colorless to yellow.

The solution was stirred for 2 hours over warm water (70° C.). Next, the solution was concentrated to 50 ml using a rotary evaporator. The solution was then precipitated using a 3M sodium chloride and 95% ethanol. The color of the precipitate was yellow brown. The precipitate was washed with 70% ethanol twice and then dried in air. Then the dried precipitate was placed into a glass furnace and heated to 225° C. for 3 hours under nitrogen. The final product was brown. XRD analysis of the resulting solid showed the formation of a mixture of tungsten oxide, bismuth oxide and bismuth tungstate.

3I. Preparation of Encapsulated Tungsten-Doped Titanium Dioxide Nanoparticles Using Polyacrylic Acid (PAA):

This example shows a method of producing polymer-encapsulated, tungsten-doped titanium oxide, where sodium tungstate is used as a tungsten source. The method includes (a) dissolving a polymer (e.g., a polyelectrolyte) in an aqueous solution under solution conditions that render the polymer in a configuration that allows the polymer to closely associate with a nanoparticle precursor, (b) adding a nanoparticle precursor and a tungsten source to the solution under conditions that cause the nanoparticle precursor to associate with the polymer, (c) modifying the nanoparticle precursor to make the nanocatalyst, and (d) heating a dried composition in the temperature range of 200-500° C. under nitrogen. The amount of tungsten source added was found to work within a very large range, anywhere from 10 mol % to 100 mol % of the amount of nanoparticle precursor

A solution of 100 ml of 2 mg/ml PAA (Mw=1,250,000), with 5 weight % Poly(sodium styrene sulphonate), neutralized to pH 6.8 using 0.5N aqueous NaOH solution was prepared. To this solution, 360 micro liters of titanium bis(dimethyl lactate) dihydroxide (50 wt % in water) was diluted with 100 ml deionised water, and 0.01752 grams of sodium tungstate in 5 ml deionised water were added simultaneously under constant stirring. The resulting solution was then irradiated with UV light from a 254-nm wavelength UV lamp for 2 hours, during which, the color changed from colorless to yellow.

1M sodium hydroxide solution was then added to the UV treated solution to bring the pH to 10.8. The color of the solution changed to deep orange. The solution was stirred for 2 hours over warm water (70 C). Next, the solution was concentrated to 50 ml using a rotary evaporator. The solution was then precipitated using a 3m sodium chloride and 95% ethanol. The color of the precipitate was yellow brown. The precipitate was washed with 70% ethanol twice and then dried in air. Then the dried precipitate was placed in a glass furnace and heated to 225° C. for 3 hours under nitrogen. The presence of the tungsten dopant was determined by ICP analysis of the final powder.

### 4 Immobilization of Encapsulated Nanocatalyst on a Solid Support

4A. Preparation of Encapsulated Titanium Oxide Nanoparticles Using Polyacrylic Acid (PAA) on an Alumina Support:

0.5 gram of PAA encapsulated titanium oxide was dispersed in 50 ml of deionized water. To this clear solution, an alumina support was added and the resulting slurry was placed into a shaker for 4 hours. The solid mass was filtered, washed several times with distilled water, and dried.

4B. Preparation of Encapsulated Titanium Oxide Nanoparticles Using Polyacrylic Acid (PAA) on a Silica Alumina Catalysis Support:

0.5 gram of PAA encapsulated titanium oxide dispersed in 50 ml of deionized water. To this clear solution, a silica alumina catalysis support was added and the resulting slurry was placed into a shaker for 4 hours. The solid mass was filtered, washed several times with distilled water, and dried.

4C. Preparation of Titanium Oxide Flocs Using Positive and Negative Polyelectrolytes:

Equal volumes of TiO₂ on polyacrylic acid and poly(allylamine hydrochloride) were mixed together, and the resulting slurry was placed into a shaker for 4 hours. The solid mass was filtered, washed several times with distilled water, and dried.

4D. Preparation of Encapsulated Gold Nanoparticles Using Polyacrylic Acid (PAA) on an Alumina Support:

0.5 gram of PAA encapsulated gold nanoparticles was dispersed in 50 ml of deionized water. To this clear solution, an alumina support was added and the resulting slurry was placed into a shaker for 4 hours. The solid mass was filtered, washed several times with distilled water, and dried.

### 5. Photocatalytic Activities of the Polyelectrolyte Encapsulated Doped Semiconductor

5A. Evaluation of Photocatalytic Activity of PAA-Encapsulated Nitrogen-Doped TiO₂ Using Methylene Blue as an Organic Dye:

Photocatalytic activities of nitrogen-doped PAA-encapsulated titanium oxide were evaluated by measuring the decomposition rate of methylene blue. 20 mg of the nanocatalyst (from Example 3G) was dispersed in 50 ml of deionised water, and this solution was added to 100 ml of 1.0×10⁻⁵M methylene blue. The resulting solution was irradiated using a 30 W Xenon light source through a UV cut off filter under constant stirring at room temperature for 60 minutes. The above experiment was compared with the same experiment using titanium oxide without nitrogen doping. The nitrogen-doped PAA-encapsulated titanium oxide exhibited higher photocatalytic activity, as seen in FIG. 4.

5B. Evaluation of Photocatalytic Activity of PSS-Encapsulated Nitrogen, Iodine, Aluminum-Doped Bi₂O₃ Using Methylene Blue as an Organic Dye:

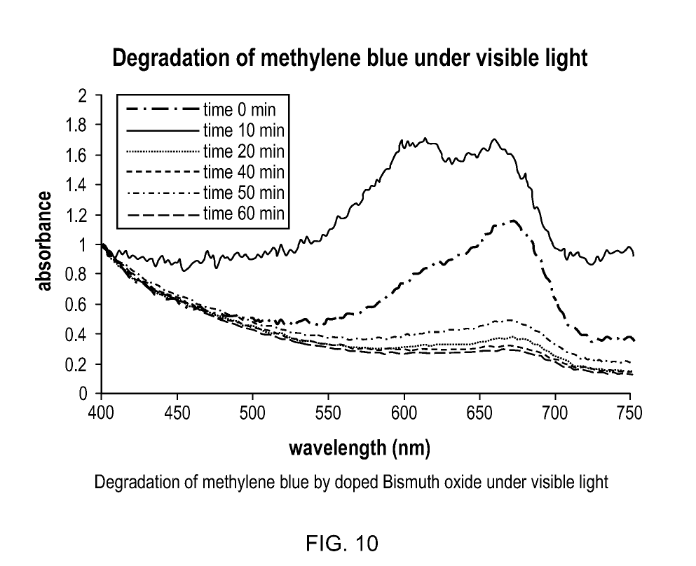

Photocatalytic activities of doped PSS-encapsulated bismuth oxide were evaluated by measuring the decomposition rate of methylene blue. 20 mg of the nanocatalyst was dispersed in 50 ml of deionised water, and this solution was added to 100 ml of 1.0×10⁻⁵M methylene blue. The resulting solution was irradiated using a 30 W Xenon light source through a UV cut off filter (>420 nm), under constant stirring at room temperature for 60 minutes. The degradation of methylene blue was monitored over a time of 60 minutes. The doped PSS-encapsulated bismuth oxide exhibited photochemical activity for degradation of organic molecule like methylene blue (FIG. 10).

5C. Evaluation of Photocatalytic Activity of PAA-Encapsulated Nitrogen-Doped TiO₂ by Decomposing Oxalic Acid:

Decomposition of oxalic acid was performed in a sealed vessel. Photocatalytic activities of nitrogen doped PAA encapsulated titanium oxide were evaluated by measuring the decomposition rate of oxalic acid (an organic compound). 20 mg of the nanocatalyst was dispersed in 50 ml of deionised water, and this solution was added to 100 ml of 1.0×10⁻⁵M oxalic acid. The solution was then irradiated using 30 W Xenon light source through a UV cut off filter under constant stirring at room temperature for 60 minutes. After that, a small portion of the gas inside the vessel was taken to measure the carbon dioxide generated using a gas chromatography. Also, the solution was titrated against a standard base to calculate the amount of acid consumed in the catalysis reaction. The above experiments were compared with undoped titanium oxide nanoparticles using the same set of experiments. The nitrogen-doped titanium oxide exhibited higher catalytic activity for decomposing oxalic acid under visible light compared to undoped titanium oxide.

5D. Evaluation of Photocatalytic Activity of PAA-Encapsulated Nitrogen-Doped TiO₂ by Decomposing Soot:

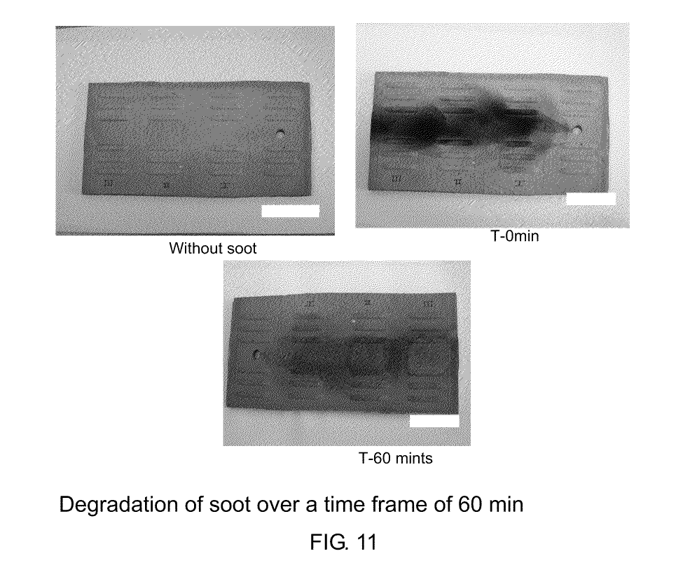

Decomposition of soot was performed on a solid support. 20 mg of the nanocatalyst was dispersed in 20 ml of deionised water, applied to a 4×4 inch tiles, and dried. A coating of soot was applied on top of the nanocatalyst, and the whole sample was irradiated using 30 W Xenon light source through a UV cut off filter, under constant stirring at room temperature for 60 minutes. After irradiation, the sample was moistened with water. The soot was almost completely destroyed by the doped PAA encapsulated titania (FIG. 11). A control experiment was also performed with undoped TiO₂, as well as the support alone.

### EQUIVALENTS

The foregoing has been a description of certain non-limiting embodiments of the invention. Those skilled in the art will recognize, or be able to ascertain using no more than routine experimentation, many equivalents to the specific embodiments of the invention described herein. Those of ordinary skill in the art will appreciate that various changes and modifications to this description may be made without departing from the spirit or scope of the present invention, as defined in the following claims.

In the claims articles such as “a,”, “an” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention also includes embodiments in which more than one, or all of the group members are present in, employed in, or otherwise relevant to a given product or process. Furthermore, it is to be understood that the invention encompasses all variations, combinations, and permutations in which one or more limitations, elements, clauses, descriptive terms, etc., from one or more of the claims or from relevant portions of the description is introduced into another claim. For example, any claim that is dependent on another claim can be modified to include one or more limitations found in any other claim that is dependent on the same base claim. Furthermore, where the claims recite a composition, it is to be understood that methods of using the composition for any of the purposes disclosed herein are included, and methods of making the composition according to any of the methods of making disclosed herein or other methods known in the art are included, unless otherwise indicated or unless it would be evident to one of ordinary skill in the art that a contradiction or inconsistency would arise. In addition, the invention encompasses compositions made according to any of the methods for preparing compositions disclosed herein.

Where elements are presented as lists, e.g., in Markush group format, it is to be understood that each subgroup of the elements is also disclosed, and any element(s) can be removed from the group. It is also noted that the term “comprising” is intended to be open and permits the inclusion of additional elements or steps. It should be understood that, in general, where the invention, or aspects of the invention, is/are referred to as comprising particular elements, features, steps, etc., certain embodiments of the invention or aspects of the invention consist, or consist essentially of, such elements, features, steps, etc. For purposes of simplicity those embodiments have not been specifically set forth in haec verba herein. Thus for each embodiment of the invention that comprises one or more elements, features, steps, etc., the invention also provides embodiments that consist or consist essentially of those elements, features, steps, etc.

Where ranges are given, endpoints are included. Furthermore, it is to be understood that unless otherwise indicated or otherwise evident from the context and/or the understanding of one of ordinary skill in the art, values that are expressed as ranges can assume any specific value within the stated ranges in different embodiments of the invention, to the tenth of the unit of the lower limit of the range, unless the context clearly dictates otherwise. It is also to be understood that unless otherwise indicated or otherwise evident from the context and/or the understanding of one of ordinary skill in the art, values expressed as ranges can assume any subrange within the given range, wherein the endpoints of the subrange are expressed to the same degree of accuracy as the tenth of the unit of the lower limit of the range.

In addition, it is to be understood that any particular embodiment of the present invention may be explicitly excluded from any one or more of the claims. Any embodiment, element, feature, application, or aspect of the compositions and/or methods of the invention can be excluded from any one or more claims. For purposes of brevity, all of the embodiments in which one or more elements, features, purposes, or aspects is excluded are not set forth explicitly herein.

### INCORPORATION BY REFERENCE

All references, such as patents, patent applications, and publications, referred to above are incorporated by reference in their entirety. Still other embodiments are within the scope of the following claims.

What is claimed is:

1. A method, comprising:
collapsing a polymer on a precursor moiety to form a composite comprising the polymer and the precursor moiety; and
forming a photocatalyst nanoparticle from the composite.

2. The method of claim 1, wherein the polymer comprises a polyelectrolyte.

3. The method of claim 2, wherein the polyelectrolyte comprises a material selected from the group consisting of poly(allylamine hydrochloride) (PAAH), poly(diallydimethylammonium chloride) (PDDA), polyacrylic acid (PAA), poly(methacrylic acid), poly(styrene sulfonate) (PSS), and poly(2-acrylamido-2-methyl-1-propane sulphonic acid) (PAMCS).

4. The method of claim 1, wherein the polymer has a molecular weight more than approximately 100,000 D.

5. The method of claim 1, wherein the catalyst comprises a metal, a metal complex, a metal oxide, a metal nitrate, a metal selenide, a metal telluride, or a metal sulfide.

6. The method of claim 5, wherein the catalyst comprises a material selected from the group consisting of Au, Ag, Pt, Pd, Ti, Bi, Zn, a combination thereof, an alloy thereof, titanium oxide, bismuth oxide, cerium oxide, tungsten oxide, bismuth sulphide, zinc oxide, lead oxide, zinc sulphide, lead sulphide, cadmium sulphide, cadmium selenide, and cadmium telluride.

7. The method of claim 5, wherein the catalyst comprises one or more dopants.

8. The method of claim 7, wherein the dopant comprises a material selected from the group consisting of nitrogen, iodine, fluorine, iron, cobalt, copper, zinc, aluminum, gallium, indium, cerium, lanthanum, gold, silver, palladium, platinum, aluminum oxide, and cerium oxide.

9. The method of claim 1, further comprising cross-linking the composite.

10. The method of claim 1, further comprising heating the composite.

11. The method of claim 1, further comprising associating the nanoparticle with a support.

12. The method of claim 1, further comprising irradiating the composite.

13. The method of claim 1, wherein the composite comprises more than one polymer molecule.

14. The method of claim 11, wherein the support is functionalized.

15. The method of claim 11, wherein the support comprises a material selected from the group consisting of an oxide, a carbonate, glass, brick, concrete, a clay, an alloy, a metal, a salt, and a carbon-based material.

16. The method of claim 11, wherein the support comprises a polymer.

17. The method of claim 1, further comprising forming a solution comprising a solvent and a polymer dissolved in the solvent.

18. The method of claim 17, further comprising contacting the precursor moiety to the solution.

19. The method of claim 18, wherein the precursor moiety comprises a metal-containing salt or an organo-metallic compound.

20. The method of claim 1, wherein the nanoparticle has an average particle size of approximately 1 nm to approximately 50 nm.

21. The method of claim 1, further comprising catalyzing a reaction with the nanoparticle.

22. The method of claim 21, wherein the reaction is photocatalyzed.

23. The method of claim 22, wherein the reaction is photocatalyzed with visible light.

24. A composition, comprising a doped semiconductor nanoparticle and at least one polyelectrolyte.

25. The composition of claim 24, wherein the nanoparticle comprises titanium oxide.

26. The composition of claim 24, wherein the nanoparticle comprises bismuth oxide or sulfide.

27. The composition of claim 24, wherein the nanoparticle has a diameter of less than 10 nm.

28. The composition of claim 24, wherein the composition comprises multiple polymer molecules.

29. The composition of claim 24, wherein the polyelectrolyte is cross-linked.

30. The composition of claim 24, wherein the nanoparticle is a photocatalyst.

31. A composition, comprising a nanoparticle and a polymer support comprising a polyelectrolyte.

32. The composition of claim 31, wherein the polymeric support comprises a cationic polyelectrolyte.

33. The composition of claim 31, wherein the polymeric support comprises an anionic polyelectrolyte.

34. The composition of claim 31, wherein the polymeric support comprises both a cationic polyelectrolyte and an anionic polyelectrolyte.

35. The composition of claim 31, wherein the nanoparticle comprises a semiconductor.

36. The composition of claim 31, wherein the nanoparticle comprises a doped semiconductor.

37. The composition of claim 31, wherein the nanoparticle is has a diameter less than 10 nm.

38. A method, comprising:
adding a flocculating agent to a solution comprising a polyelectrolyte-stabilized nanoparticle composite.

39. The method of claim 38, wherein the composite comprises semiconductor nanoparticles.

40. The method of claim 38, wherein the composite comprises doped semiconductor nanoparticles.

41. The method of claim 38, wherein the flocculating agent comprises a polymer that is oppositely charged to the polyelectrolyte in the composite.

42. The method of claim 38, wherein the flocculating agent comprises a counter-ion that is oppositely charged to the polyelectrolyte in the composite.

43. The method of claim 38, wherein the flocculating agent comprises a polyelectrolyte-stabilized nanoparticle composite.
